(19) United States
(12) Patent Application Publication
(10) Pub. No.: US 2024/0347796 A1
(43) Pub. Date: Oct. 17, 2024

(54) INFRARED SENSOR DEVICES AND METHODS TO DETECT ELECTROLYTE FLUID LEVELS IN BATTERY CELLS

(71) Applicants: Edward Potempa, Pittstown, NJ (US); Allan Baum, Lincoln Park, NJ (US); Francisco Gutierrez-Guerra, Wharton, NJ (US)

(72) Inventors: Edward Potempa, Pittstown, NJ (US); Allan Baum, Lincoln Park, NJ (US); Francisco Gutierrez-Guerra, Wharton, NJ (US)

(21) Appl. No.: 18/389,193

(22) Filed: Nov. 13, 2023

Related U.S. Application Data
(60) Provisional application No. 63/424,776, filed on Nov. 11, 2022.

(51) Int. Cl. H01M 10/48; G01F 23/292

(52) U.S. Cl. CPC H01M 10/484; G01F 23/2928

(57) ABSTRACT

Various embodiments of compact IR sensor devices/modules are disclosed herein that can be mounted or attached to an outside surface of a battery cell and generate and transmit IR light into the battery fluid, and receive the IR light reflected by the battery fluid. Based on the amount of IR light reflected by the battery electrolyte fluid and received by an IR sensor device, the IR sensor device determines and generates alert signals if the battery electrolyte fluid level within the battery cell has dropped below a low level. Other features, structures, processes and embodiments of the present disclosure are presented herein.

### CROSS-REFERENCE TO RELATED APPLICATION

This application claims the benefit of under 35 U.S.C. 119(e), and priority to, U.S. Provisional Patent Application No. 63/424,776 filed Nov. 11, 2022 entitled “Infrared Sensor Devices and Methods to Detect Electrolyte Fluid Levels in Battery Cells” the disclosure of which is hereby incorporated by reference in its entirety.

### TECHNICAL FIELD

This application generally relates to battery monitoring, and more particularly to monitoring the fluid levels within battery cells.

### BACKGROUND

Battery cells, such as used to provide backup power for large data centers, contain electrolyte fluid within the battery cells. If the level of the electrolyte fluid drops below a desired level, the battery can fail to operate properly. The present inventors have recognized that some conventional battery fluid monitoring devices can require extensive calibration by persons that install such conventional devices. The present inventors have also recognized that once some conventional battery fluid monitoring devices are attached to a battery cell, if the battery cell needs replacement, it can be difficult to remove and replace the conventional battery fluid monitoring device.

### SUMMARY

As recognized by the present inventors, what is needed are devices and methods for monitoring the fluid levels in battery cells. According to one broad aspect of one embodiment of the present disclosure, disclosed herein are compact IR sensor devices/modules that can be mounted or attached to an outside surface of a battery cell and generate and transmit IR light into the battery fluid, and receive the IR light reflected by the battery fluid. Based on the amount of IR light reflected by the battery electrolyte fluid and received by an IR sensor device, the IR sensor device determines and generates alert signals if the battery electrolyte fluid level within the battery cell has dropped below a low level.

According to another broad aspect of another embodiment of the present disclosure, disclosed herein is a device to detect the level of fluid within a battery where the battery has a low-level fluid line. In one example, the device may include a housing having an indicator on the housing adapted to be aligned with the low-level fluid line of the battery, the housing adapted to be attached to an outside surface of the battery; a first infrared (IR) light transmitter positioned within the housing, the first transmitter transmitting IR light into the fluid of the battery; a first IR light receiver positioned within the housing, the first IR light receiver receiving IR light from the first IR light transmitter that is reflected by the fluid of the battery; wherein the first IR light transmitter and first IR light receiver are positioned above the indicator; a second IR light transmitter positioned within the housing, the second transmitter transmitting IR light into the fluid of the battery; and a second IR light receiver positioned within the housing, the second IR light receiver receiving IR light from the second IR light transmitter that is reflected from the fluid of the battery; wherein the second IR light transmitter and second IR light receiver are positioned below the indicator.

In one embodiment, the indicator may be formed as a pair of lateral alignment notches, each notch defined in a side of the housing.

In one embodiment, the first IR light transmitter may be a light emitting diode (LED) generating IR light at a wavelength of 940 nano meters, and the first IR light receiver can be a photo transistor. The second IR light transmitter may be a light emitting diode (LED) generating IR light at a wavelength of 940 nano meters, and the second IR light receiver may be a photo transistor.

In one example, the IR light from the second IR light transmitter is detected by the second IR light receiver to determine a reference value of reflected IR light through the fluid. The IR light from the first IR light transmitter can be detected by the first IR light receiver to determine the level of the fluid relative to the low-level fluid line in order for the device to generate an initial warning if the level of the fluid falls below the low-level fluid line. The IR light from the second IR light transmitter may be detected by the second IR light receiver to determine the level of the fluid relative to the low-level fluid line in order for the device to generate an urgent critical warning if the level of the fluid falls substantially below the low-level fluid line.

The device may also include a circuit board having electronics such as control electronic and the first IR light transmitter, the first IR light receiver, the second IR light transmitter and the second IR light receiver.

The housing may also include a base member and a removable cover, the cover connected with the base member, with the circuit board being attached to the cover. When the housing is attached to the battery cell, the cover and circuit board are detachable from the base member and the battery cell. In this manner, the electronics and the cover can be removed from the base member and the battery cell, so that the electronics of the device can be re-used and attached to other battery cells.

The first IR light transmitter and the first IR light receiver may be vertically aligned with the second IR light transmitter and the second IR light receiver.

In one example, the first IR light transmitter pulses the IR light at a frequency of 80 Hz, and the first IR light receiver receives the IR light from the first IR light transmitter at the pulsed 80 Hz frequency and in phase with the 80 Hz IR light. The second IR light transmitter pulses the IR light at a frequency of 80 Hz, and the second IR light receiver receives the IR light from the second IR light transmitter at the pulsed 80 Hz frequency and in phase with the 80 Hz IR light.

According to another broad aspect of another embodiment of the present disclosure, disclosed herein is a device to detect the level of fluid within a battery where the battery has a low-level fluid line. In one example, the device may include a housing having at least a pair of alignment notches defined in the housing, the notches adapted to be aligned with the low-level fluid line of the battery, the housing adapted to be attached to an outside surface of the battery; a first infrared (IR) light transmitter positioned within the housing, the first transmitter transmitting IR light into the fluid of the battery; a first IR light receiver positioned within the housing, the first IR light receiver receiving IR light from the first IR light transmitter that is reflected by the fluid of the battery; wherein the first IR light transmitter and first IR light receiver are positioned above the notches; a second IR light transmitter positioned within the housing, the second transmitter transmitting IR light into the fluid of the battery; and a second IR light receiver positioned within the housing, the second IR light receiver receiving IR light from the second IR light transmitter that is reflected from the fluid of the battery; wherein the second IR light transmitter and second IR light receiver are positioned below the notches.

In one example, the first IR light transmitter is a light emitting diode (LED) generating IR light pulsed at a frequency of 80 Hz, the IR light having a wavelength of 940 nano meters. The first IR light receiver receives the IR light from the first IR light transmitter at the pulsed 80 Hz frequency and in phase with the 80 Hz IR light.

In one embodiment, the base member defines a first baffle positioned around a portion of the first IR light receiver to guide IR light into the first IR light receiver as well as to block some amounts of spurious light from interfering with the first IR light receiver; and the base member defines a second baffle positioned around a portion of the second IR light receiver to guide IR light into the second IR light receiver as well as to block some amounts of spurious light from interfering with the second IR light receiver. Baffles may also be used and positioned around the first IR light transmitter and the second IR light transmitter.

Other embodiments of the disclosure are described herein. The features, utilities and advantages of various embodiments of this disclosure will be apparent from the following more particular description of embodiments as illustrated in the accompanying drawings.

### BRIEF DESCRIPTION OF THE FIGURES

FIG. 1 illustrates a perspective view of an example of an IR sensor device/module to detect electrolyte fluid levels in a battery cell, in accordance with one embodiment of the present disclosure.

FIG. 2 illustrates a left side view of the IR sensor device of FIG. 1, in accordance with one embodiment of the present disclosure.

FIG. 3 illustrates a front view of the IR sensor device of FIG. 1, in accordance with one embodiment of the present disclosure.

FIGS. 4A-B illustrate an example of an IR sensor device mounted to an exterior surface of a battery cell to detect electrolyte fluid levels in the battery cell, in accordance with one embodiment of the present disclosure.

FIG. 5 illustrates a perspective view of a cover of an IR sensor device, in accordance with one embodiment of the present disclosure.

FIG. 6 illustrates a left side view the cover of FIG. 5, in accordance with one embodiment of the present disclosure.

FIG. 7 illustrates a perspective view of the rear side/interior of the cover of FIG. 5, in accordance with one embodiment of the present disclosure.

FIG. 8 illustrates a view of the interior of the cover of FIG. 5, in accordance with one embodiment of the present disclosure.

FIGS. 9-10A-B illustrate an interior view of the cover of FIG. 5 with a circuit board positioned and secured within the interior of the cover, in accordance with some embodiments of the present disclosure.

FIG. 11 illustrates a bottom view of the cover of FIGS. 10A-B with a circuit board positioned and secured within the interior of the cover, in accordance with one embodiment of the present disclosure.

FIGS. 12-13 illustrate a base member of an IR sensor device, showing an interior view of the base member, in accordance with one embodiment of the present disclosure.

FIG. 14 illustrates an exterior surface of the base member of FIG. 12, in accordance with one embodiment of the present disclosure.

FIG. 15 illustrates a right side view of the base member of FIG. 12, in accordance with one embodiment of the present disclosure.

FIGS. 16A-B illustrate an exploded view of an IR sensor device with a cover, circuit board, and base member, in accordance with one embodiment of the present disclosure.

FIGS. 17-18 illustrate an example of an IR sensor device mounted to an exterior surface of a battery cell to detect electrolyte fluid levels in the battery cell, in accordance with one embodiment of the present disclosure.

FIGS. 19-20 illustrate an example of a base member mounted to an exterior surface of a battery cell, wherein the cover and circuit board are detached from the base member, in accordance with one embodiment of the present disclosure.

FIGS. 21-22 illustrate examples of interconnecting a series of IR sensor devices with an interface module/power supply, wherein each of the IR sensor devices is mounted on a battery cell to detect electrolyte fluid levels in the respective battery cell, in accordance with one embodiment of the present disclosure.

FIG. 23 illustrates a block diagram of an example of an IR sensor device to detect electrolyte fluid levels in a battery cell, in accordance with an embodiment of the present disclosure.

FIG. 24 illustrates another block diagram of an example of an IR sensor device to detect electrolyte fluid levels in a battery cell, in accordance with an embodiment of the present disclosure.

FIGS. 25A-B illustrate an example of a process for an IR sensor device to detect electrolyte fluid levels in a battery cell, in accordance with an embodiment of the present disclosure.

FIGS. 26A-B illustrate an example of another process for an IR sensor device to detect electrolyte fluid levels in a battery cell, in accordance with an embodiment of the present disclosure.

FIGS. 27A-B illustrate an example of another process for an IR sensor device to detect electrolyte fluid levels in a battery cell, in accordance with an embodiment of the present disclosure.

### DETAILED DESCRIPTION

Disclosed herein are various embodiments of devices and methods for detecting electrolyte fluid levels in battery cells 52 using infrared (IR) sensors devices 50. Various embodiments of compact IR sensor devices/modules 50 are disclosed herein that can be mounted or attached to an outside surface of a battery cell 52 and generate and transmit IR light into the battery fluid 66, and receive the IR light reflected by the battery fluid 66. Based on the amount of IR light reflected by the battery electrolyte fluid 66 and received by an IR sensor device 50, the IR sensor device 50 determines and generates alert signals if the battery electrolyte fluid level 64 within the battery cell 52 has dropped below a low level. Other features, structures, processes and embodiments of the present disclosure are presented herein.

As used herein, the terms of “battery fluid”, “fluid”, “electrolytes”, “electrolyte fluid”, and any combination thereof are used interchangeably refer to the fluid 66 within a battery or battery cell 52.

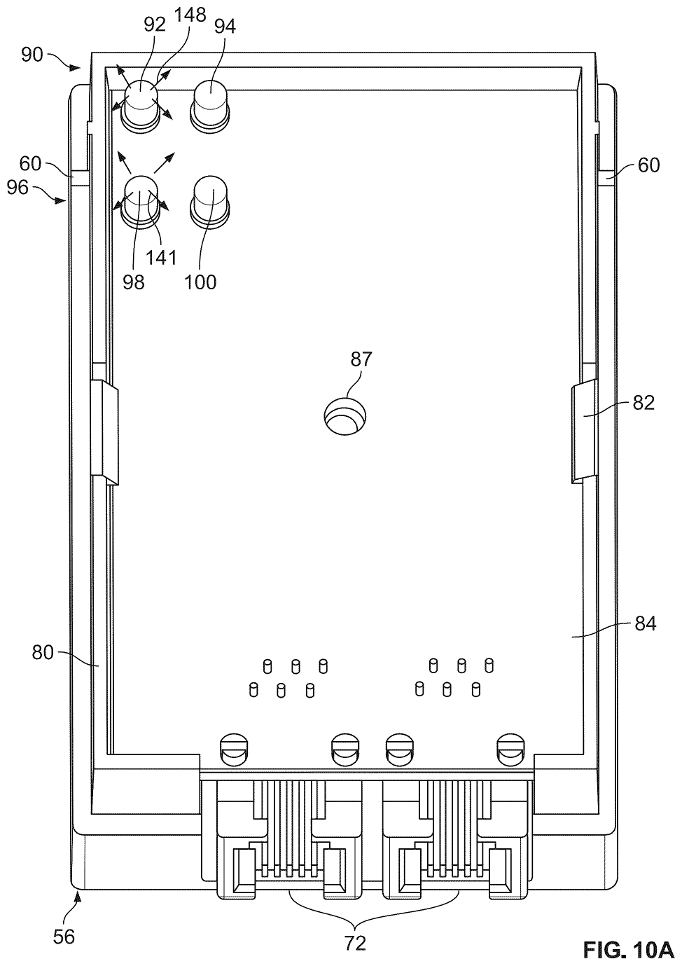

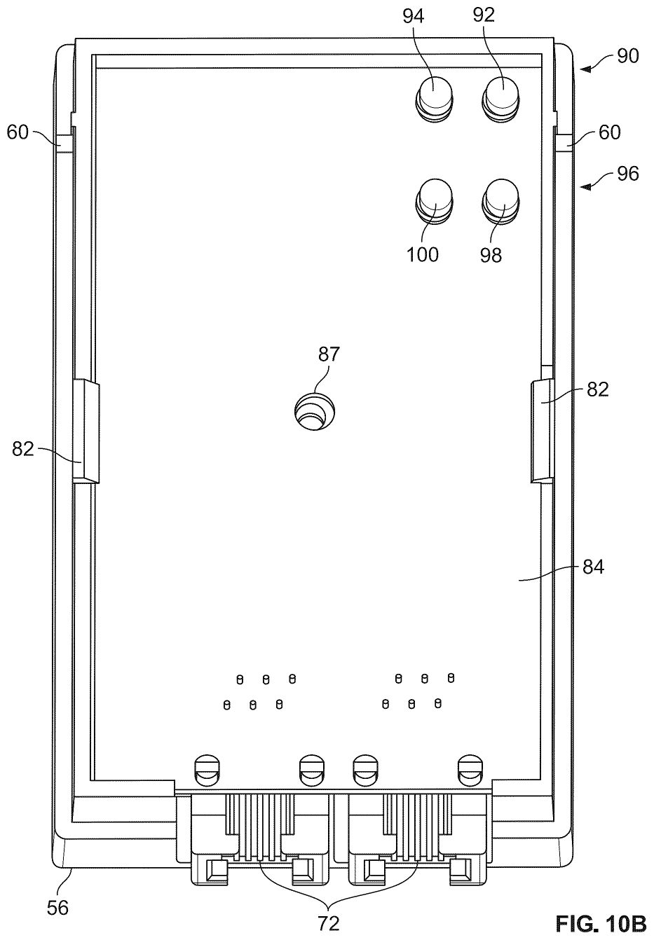

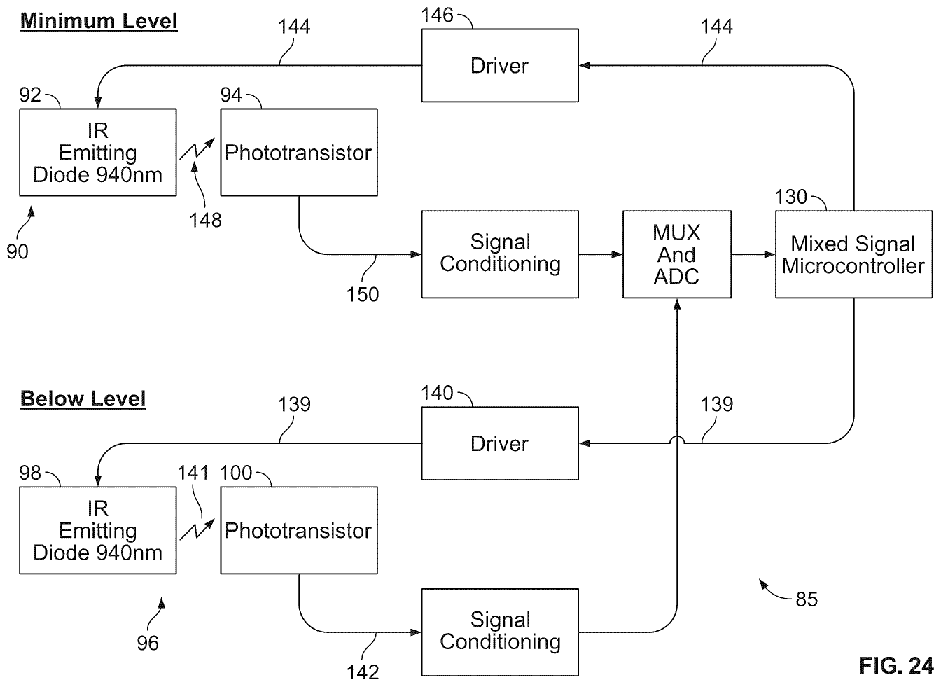

In one example of an embodiment of the present disclosure, two pairs 90, 96 of IR transmitters-receivers are used in an IR sensor module/device 50. An upper set 90 including an IR light emitting diode 92 (LED which acts as an IR transmitter, in one example at 940 nm) and an IR phototransistor 94 (which acts as an IR light receiver) are positioned laterally in parallel with each other, and transmit IR light 148 (FIGS. 10A and 24) into the battery cell 52. This upper pair 90 is adapted to be positioned above a Minimum Fluid Level line 53 of the battery cell 52.

A lower set 96 of an IR transmitter-receiver can include an IR LED 98 (which acts as an IR transmitter, in one example at 940 nm) and an IR phototransistor 100 (which acts as an IR light receiver) are positioned laterally in parallel with each other, and transmit IR light 141 (FIGS. 10A and 24) into the battery cell 52. This lower pair 96 is adapted to be positioned below the Minimum Fluid Level line 53 of the battery cell 52, so that this lower set 96 will be transmitting IR light 141 into the body of the electrolyte fluid 66 of the battery cell 52. As described herein, this lower pair 96 provides a set of reference values of light reflectance through the electrolyte fluid 66 of the battery cell 52, and the reference values are used to provide a self-calibration feature.

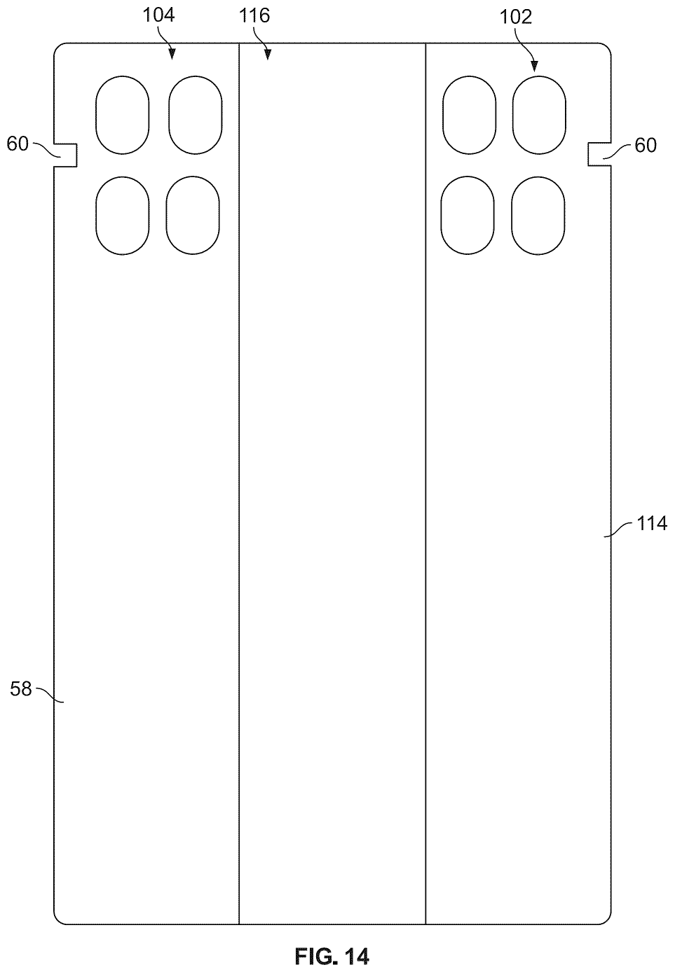

In one embodiment, the IR sensor device 50 has a compact housing 54 that includes an indicator 60 which in one example is in the form of an alignment notch 60 on each side of the housing 54, wherein the notch 60 provides a visual and physical indicator to aid the user in positioning the device 50 on the battery 52. In one example, the IR sensor device 50 can be positioned by the user on the battery 52 such that the alignment notch 60 on the IR sensor device housing 54 aligns with the Low-Level fluid line 53 of the battery 52. The IR sensor device 50 can be mounted and secured to a battery 52 in a precise desired location using adhesives such as double-sided adhesive tape (i.e., from 3M Corporation) (see also FIG. 14).

In operation, in one example, the IR sensor device 50 detects the battery electrolyte fluid/water level 64 based on the absorption and reflection of IR light 141, 148 passed thru the battery fluid 66. The IR sensor device 50 generates and transmits IR light 141, 148 into the battery electrolyte fluid 66, and monitors the IR reflection of said transmitted IR light. When there is a full amount of electrolyte fluid 66 in the battery 52 thru which the IR light from the device 50 passes, the amount of IR light reflected from the battery's cell 52 and detected by the IR sensor device 50 will be lower since the fluid/water 66 will absorb portions of the IR light. Conversely, when there is diminishing or no electrolyte fluid/water 66 in the battery's cell 52 that the IR light from the device 50 passes thru, the amount of IR light reflected from the battery's cell 52 and detected by the IR sensor device 50 will be higher.

Stated differently and as described herein, in one example of the present disclosure, the IR sensor device 50 includes an infrared (IR) light transmitter 92 (i.e., an IR LED emitting at 940 nm) and an IR receiver 94 (i.e., an IR phototransistor) that are horizontally aligned and can be positioned above the alignment notch 60. In one example, this top IR transmitter/receiver pair 90 can be used to detect the battery fluid level 64 relative to the desired minimum fluid level (Low-Level fluid line 53) of the battery 52. This IR light transmitter and receiver pair 90 is referred to herein as the “Minimum Level” fluid detector 90, and can generate a low-level alarm or initial warning if the battery fluid level 64 is detected to be near or below the Low-Level fluid line 53.

The IR sensor device 50 may also include an additional IR light transmitter 98 (i.e., an IR LED emitting at 940 nm) and an IR receiver 100 (i.e., an IR phototransistor) that are horizontally aligned and positioned below the alignment notch 60 (and therefore below the Low-Level fluid line 53 of the battery 52). This second lower IR transmitter/receiver pair 96 can be used to detect whether the battery fluid level 64 is below the desired minimum fluid level (Low-Level fluid line 53) of the battery 52; and can trigger a more urgent/critical Equipment alarm (which is more severe that the above-described low-level alarm/warning) when the device 50 detects that the battery fluid level 64 is substantially well below the Low-Level fluid line 53 or when the device 50 detects that no battery fluid 66 is present in the battery 52. This IR light transmitter 98 and receiver 100 pair 96 is referred to herein as the “Below Level” fluid detector 96.

Since this second IR transmitter/receiver pair 96 is positioned below the Low-Level fluid line 53 of the battery 52, at initialization of the device 50 when the battery fluid level 64 is normal (i.e., above the Low-Level fluid line 53), this IR transmitter/receiver pair 96 will be transmitting IR light 141 into the electrolyte fluid 66 within the battery 52, and the amount of reflected IR light detected by this IR receiver 100 can be stored and used as a reference value by the device 50 for use in comparisons, calculations and detections of the electrolyte fluid level 64 within the battery 52.

In one example of the IR sensor device 50, the IR transmitter 92 of the upper/Minimum Level fluid detector 90 may be vertically aligned with and positioned above the IR transmitter 98 of the lower/Below Level fluid detector 96. In one example of the device, the IR receiver 94 of the upper/Minimum Level fluid detector 90 may be vertically aligned with and positioned above the IR receiver 100 of the lower/Below Level fluid detector 96.

In another example, the IR sensor device 50 includes a detachable, removable top cover 56 with a circuit board 84 (having electronics 85 including IR transmitters-receiver pairs 90, 96) attached to the top cover 56, and a base member 58 that removably connects with the top cover 56. The base member 58 can be attached to an exterior surface of the battery cell jar 52 with adhesive tape. If the battery cell 52 has to be replaced, the top cover 56 with circuit board 84 and electronics 85 of IR sensor device 50 can be detached and removed from the base member 58, so that the top cover 56 with electronics 85 of IR sensor device 50 can be removed/detached from the battery cell 52. This permits the top cover 56 with the circuit board 84 and electronics 85 of IR sensor device 50 to be attached to a new battery cell using a new base member.

In another example, the IR sensor device 50 includes a base member 58 with two sets of light port holes 102, 104 and circuit board 84 structure so that the IR sensor device 50 can be configured with IR sensors 90, 96 positioned on the left side (FIG. 10B) of the rear surface of the IR sensor device 50, or configured with IR sensors positioned on the right side (FIG. 10A) of the rear surface of the IR sensor device 50. This structure allows the IR sensor device 50 to be positioned on a battery cell 52 to avoid reflections from internal battery cell components (such as plates, fill tubes, hangers, etc.) and/or reflections from graphics/printing on the case of the battery cell 52. With the IR sensors 90, 96 positioned on the left of the device 50, the IR sensor module 50 can be positioned very close to the edge of the battery cell 52. Similarly, a version of the IR sensor module 50 with the IR sensors 90, 96 near the right portion of the device 50, the IR sensor module 50 can be positioned very close to the edge of the battery cell 52 to avoid reflections from internal battery cell components (such as plates, fill tubes, hangers, etc.) and/or reflections from graphics/printing on the case of the battery cell 52.

In another embodiment of the present disclosure, the IR sensor device 50 may implement a process wherein measurements of the electrolyte fluid level 64 within the battery cell 52 are taken repeatedly over a first interval of time (i.e., every 15 seconds) during an initial time period (i.e., for the first 5 minutes), and then these measurements are taken repeatedly less frequently over a second time period (i.e., one measurement every minute thereafter), in one example. This process helps save power/electricity used by the IR sensor module 50.

In another embodiment of the present disclosure, the IR sensor device/module 50 pulses each of the IR LED transmitters 92, 98 at a frequency that is not a harmonic of 50 Hz or of 60 Hz. For instance, the IR sensor module 50 pulses each of the IR LED transmitters 92, 98 at a frequency of 80 Hz so that the respective IR phototransistor/receivers 94, 100 detect the level of IR light received at the pulsed 80 Hz frequency and in phase with the emitted 80 Hz IR light from the IR LED transmitters 92, 98, which thereby minimizes optical interference caused by artificial lighting operating at 60 Hz or other spurious noise.

The detailed description herein refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the embodiments. Many other embodiments may be utilized for practicing the subject matter other than the illustrative examples discussed herein, and many structural and operational changes in addition to the alternatives specifically discussed herein may be made without departing from the scope of the disclosed subject matter.

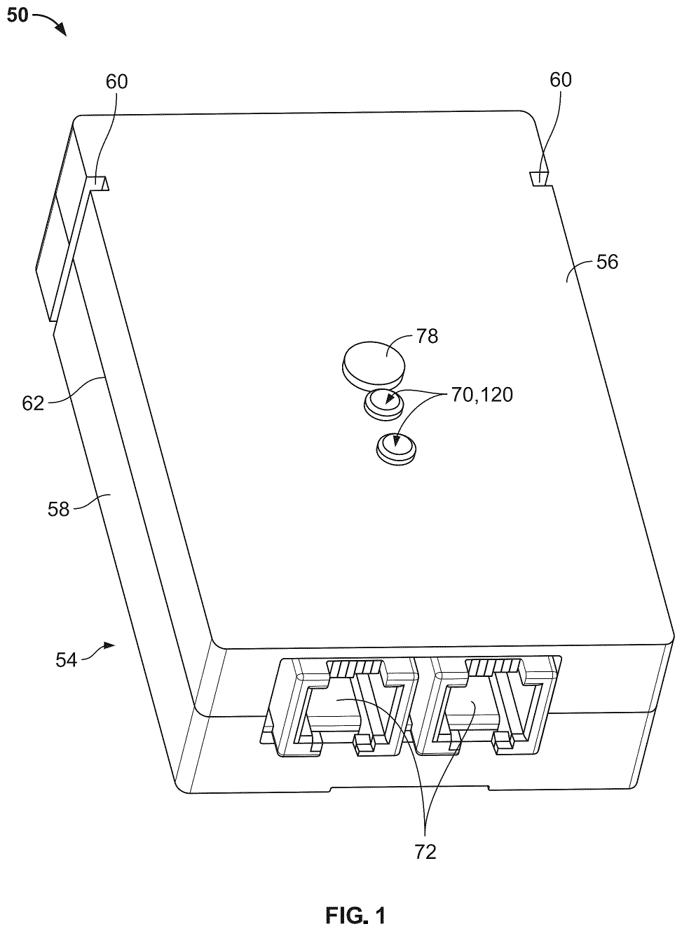

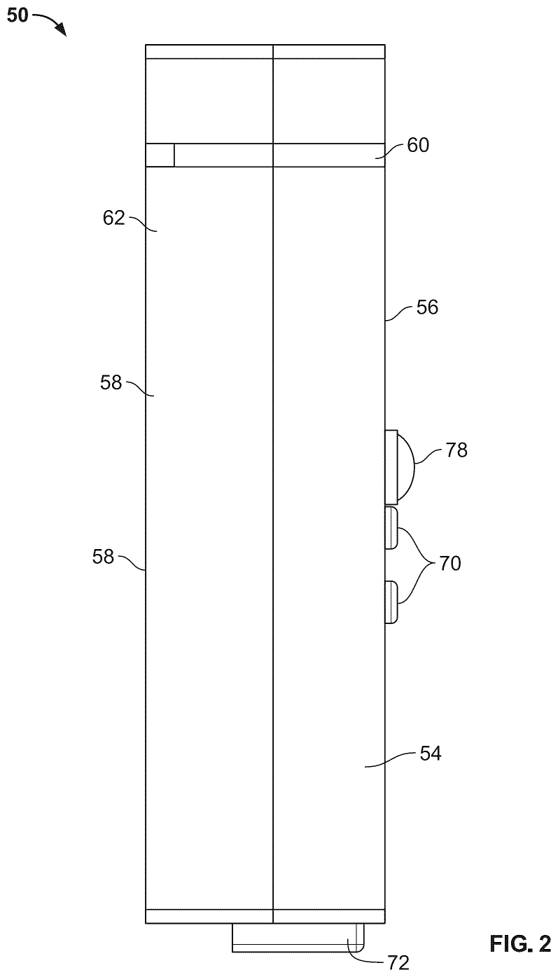

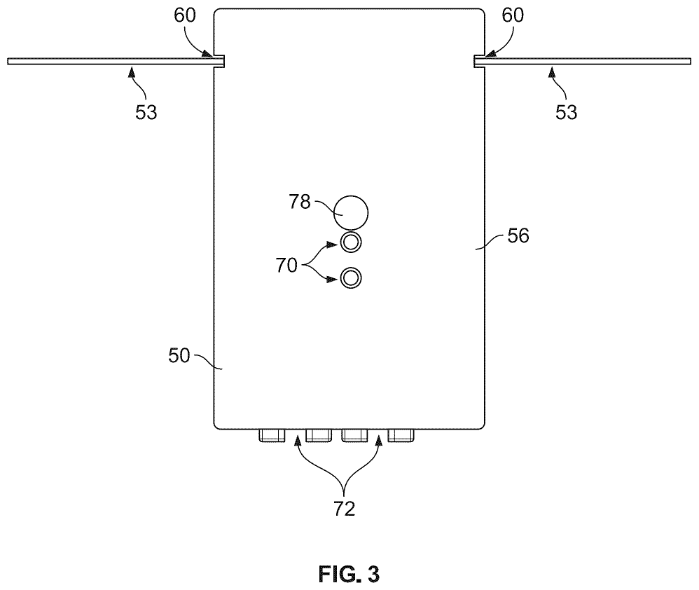

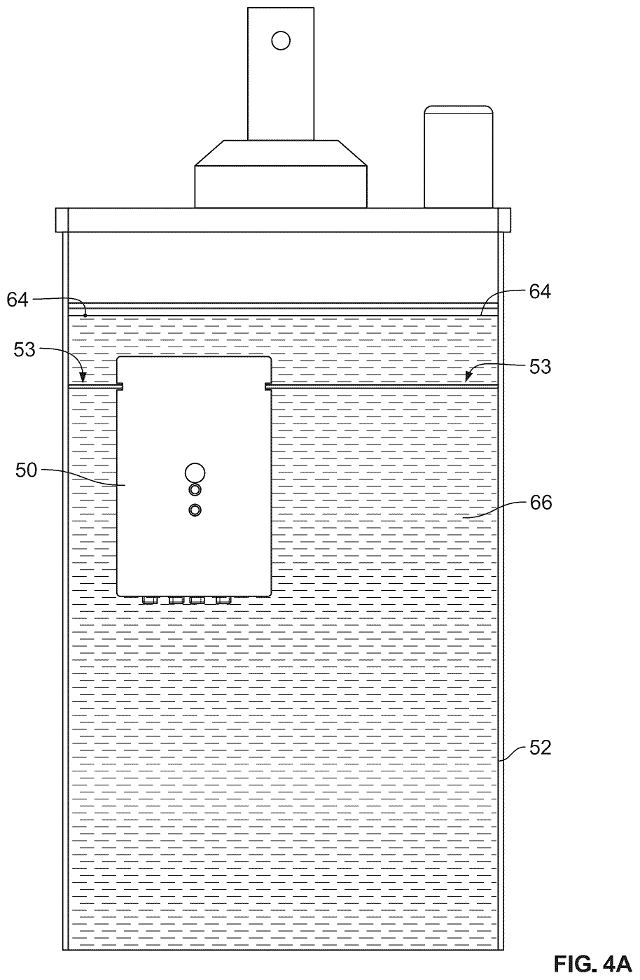

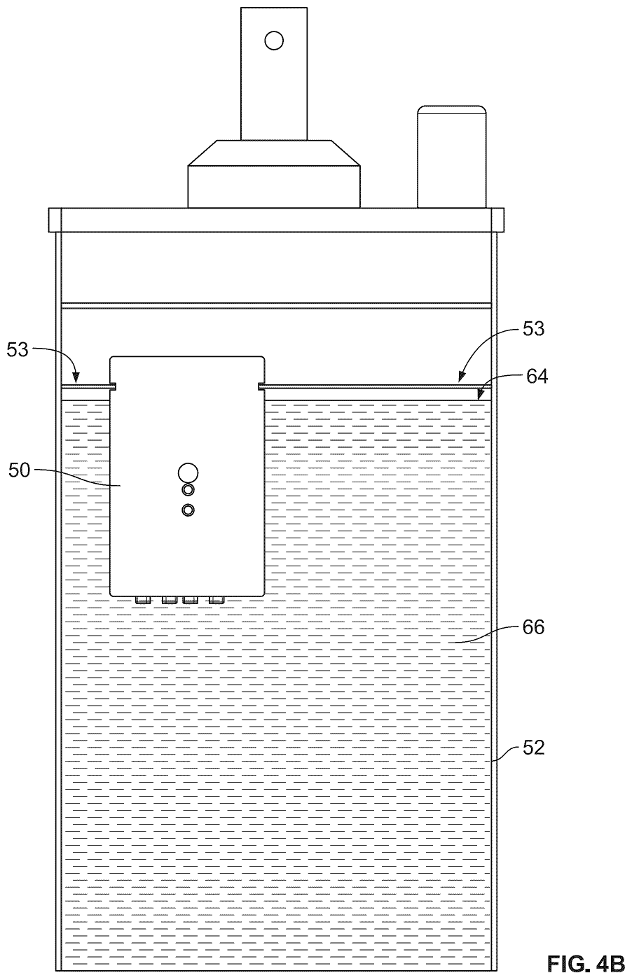

Referring now to FIGS. 1-4A/B, an IR sensor device 50 is illustrated for use with a battery cell 52 having a low-level fluid line 53 on the battery 52. The device 50 has a housing 54 formed by a removable top cover 56 connected with a base member 58. The top cover 56 and base member 58 can have parallel alignment notches/indicators 60 defined along the sides 62 of an upper portion of the housing 54 of the IR sensor device 50. The alignment notches 60 help provide visual reference points to a user to assist the user in positioning the IR sensor device 50 on exterior surface of a battery cell 52 at the appropriate position so that the IR sensor device 50 can monitor the electrolyte fluid level 64 of the battery fluid 66 within the battery cell 52. In one example and as shown in FIGS. 3, 4A-B, the device 50 can be positioned by the user on the battery 52 such that the alignment notch 60 on the device housing 54 aligns with the Low-Level fluid line 53 of the battery 52.

In one example, each alignment notch/indicator 60 on the housing is a thin longitudinal notch or lateral channel defined in the outer portion/sides 62 of the housing 54. Each alignment notch/indicator 60 may be 0.875 inches long (defined along each side of the housing), have a height of 0.079 inches, and have a depth of 0.0475 inches in one embodiment; other dimensions of the alignment notch/indicator 60 can be used depending upon the particular implementation. In this manner, the alignment notch/indicator 60 provides an effective visual reference for a user to match up the position of the alignment notches 60 of the device 50 to the Low-Level fluid line 53 of the battery cell 52, so that the device 50 can be attached to the battery cell 52 in the correct location to provide proper operation of the device 50.

The top cover 56 of the IR sensor device 50 may also include one or more LED status indicator lights 70, for instance to indicate that the fluid level 64 is “OK” (such as via a green LED) or that there is a low fluid level condition detected (such as via a flashing red LED). As an example, the IR sensor device 50 may include two or more indicator lights 70 on the front face/cover 56 of the device 50—such as a green indicator light and a red indicator light which may be implemented using LEDs. In one example, when the battery fluid level 64 is detected to be above the low-level line 53, the IR sensor device 50 illuminates the green light indicator 70 as a continuous/solid green light. When the battery fluid level 64 is detected to be below the low-level line 53, the IR sensor device 50 illuminates the red light indicator 70 as a continuous/solid red light. When the battery fluid level 64 is detected to be well below the low-level line 53 or no fluid 66 is detected (such as due to a leak in the battery cell 52), the IR sensor device 50 illuminates the red light indicator 70 as a flashing red light to indicate an urgent or critical equipment alarm. In another embodiment, prior to taking a measurement, the IR sensor device 50 can flash or cycle lights 70, such as an active green light or an active red light, to indicate that a measurement is about to take place (this also can indicate that the IR sensor device 50 is operating properly).

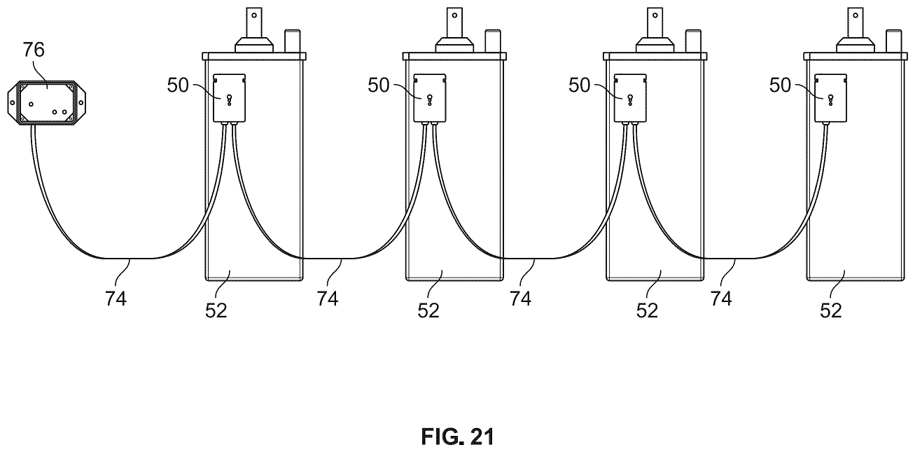

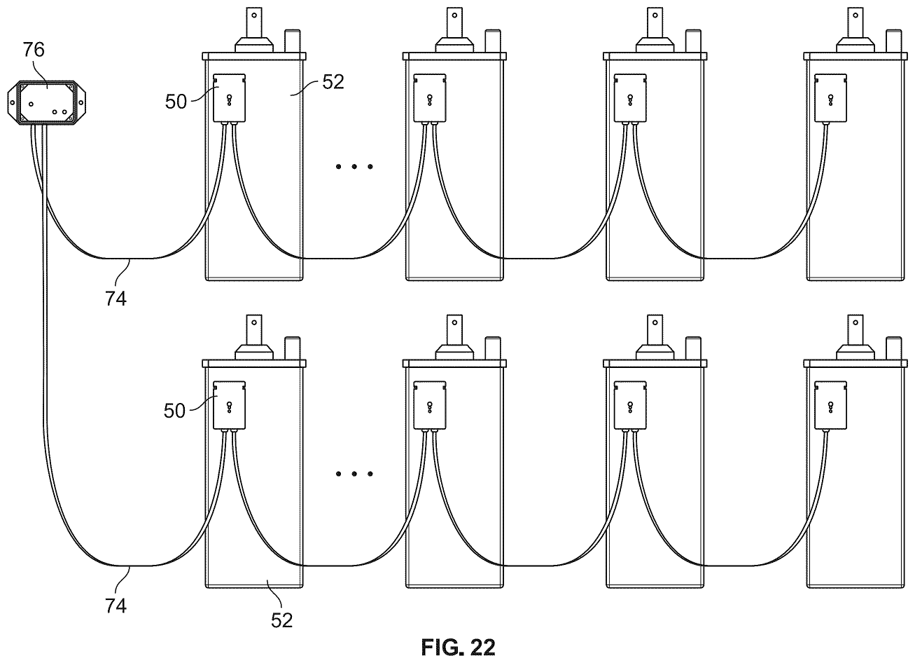

Wiring or signal ports 72 can be provided, for instance in the lower portion or bottom of the housing 54. In one example, a 4 wire signal bus 74 (FIGS. 21-22) is connected with the IR sensor device 50, with the bus wires 74 including power (such as 24 v DC), ground, and 2 output signal wires to indicate an alarm condition. As shown in FIGS. 21-22, multiple IR sensor devices 50 can be interconnected such as in a daisy chain configuration, and connected to an interface module/power source 76. In one example, the interface module/power source 76 is a Model S5, S6, CellQ1, or CellQ2 manufactured by BTECH Inc. of Rockaway, New Jersey. In this manner, the fluid levels 64 of multiple battery cells 52 can be simultaneously monitored each by a respective IR sensor device 50 having one or more features or processes described herein.

The top cover 56 of the IR sensor device 50 may also have a screw cover 78 which covers a screw 89 or other attachment mechanism that is used to selectively connect the top cover 56 to the base member 58, as will be described below.

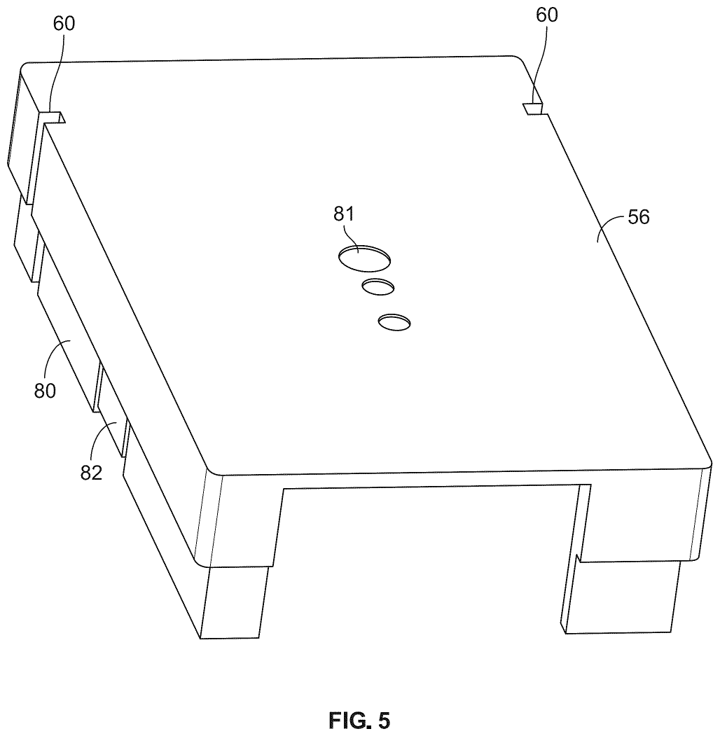

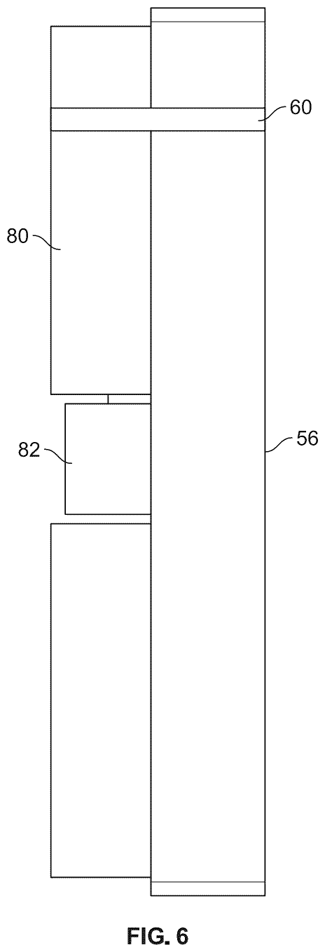

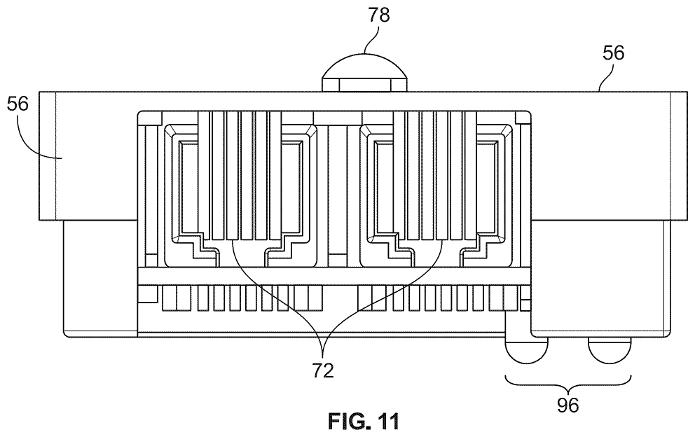

FIGS. 5-11 illustrate various features of the cover 56 of the IR sensor module 50, in accordance with one embodiment of the present disclosure. The cover 56 includes an inner frame wall 80 defined within the portions of the perimeter of the cover 56. The inner frame wall 80 is defined along the top and sides of the cover 56, and is formed to extend downwardly into the base member 58 when the cover 56 is connected to the base member 58.

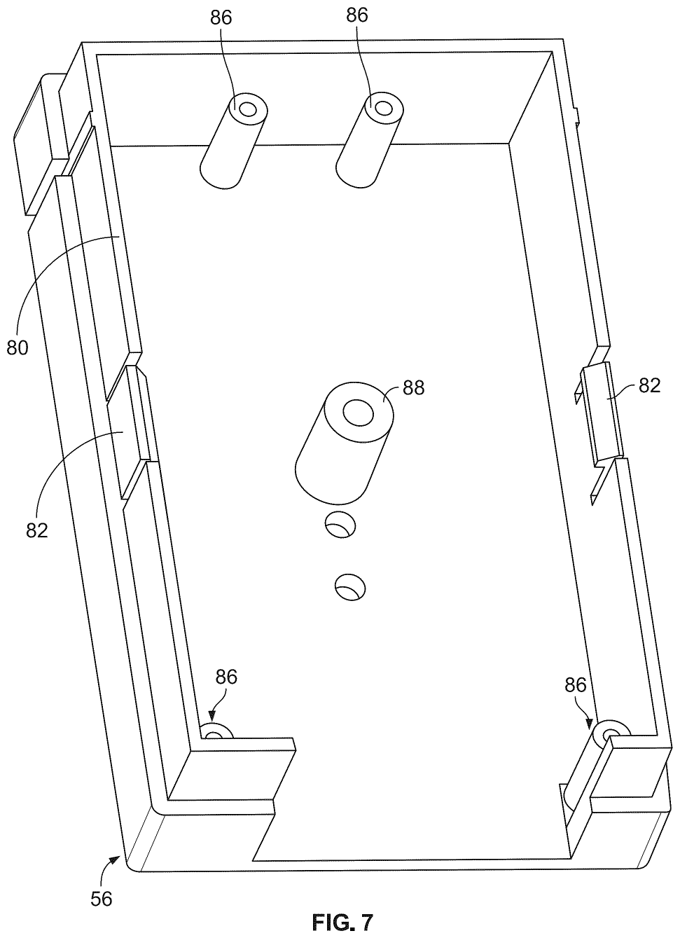

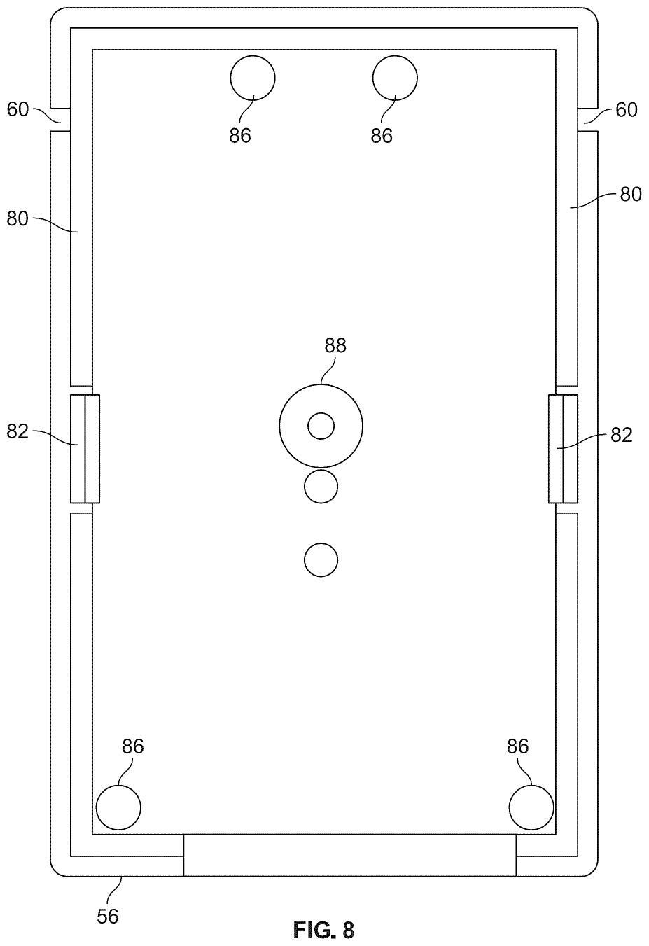

The inner wall 80 also includes a pair of tabs 82 along the side portions of the inner wall 80. The tabs 82 are formed to receive and secure a circuit board 84 and electronics 85 within the interior portion of the cover 56. As shown on FIGS. 7-8, the interior portion of the cover 56 may include one or more support posts or support columns 86 that help position and retain the circuit board 84 within the cover 56.

In FIGS. 7-8, the cover 56 may also include a guide post 88 with an opening 81 or channel defined therein to receive the shaft of a screw 89 or other element to be attached to the cover, thru an opening 87 of the circuit board 84 and terminating in the base member 58.

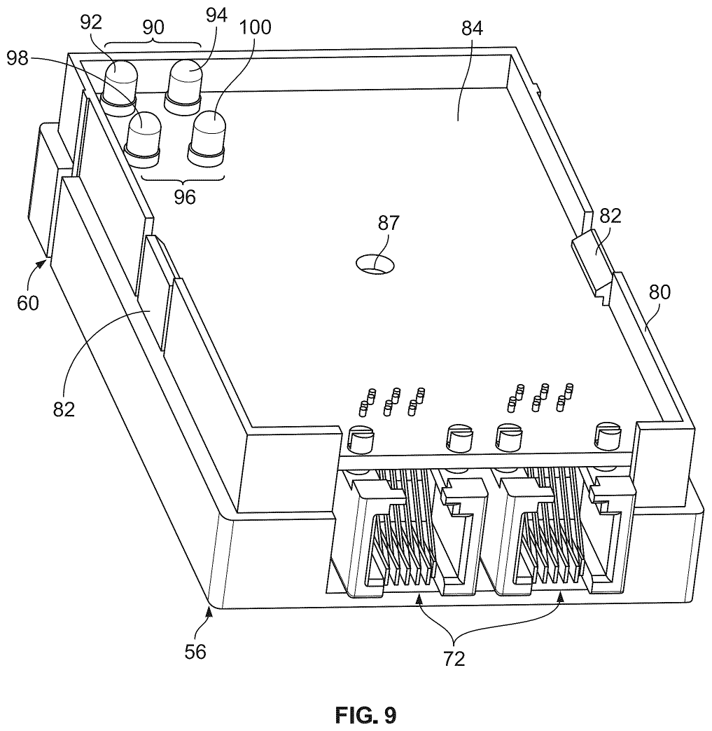

In FIGS. 9, 10A-B, the cover 56 has a circuit board 84 positioned and secured within the interior of the cover 56. Here, it can be seen that two sets of IR transmitter-receiver pairs 90, 96 are provided. The upper/top set 90 (an IR transmitter 92 and an IR receiver 94) is referred to herein as the “Minimum Level” IR transmitter-receiver 90, and are used as described herein to monitor the fluid level 64 within the battery cell 52 and can trigger an alarm if the fluid level 64 drops below the position of these “Minimum Level” IR transmitter-receiver 90.

The lower set 96 (IR transmitter 98 and IR receiver 100) is referred to herein as the “Below Level” IR transmitter-detector 96. These “Below Level” IR transmitter-detector 96 are used to self-calibrate the IR sensor device 50 as described herein; and can be used to detect if the battery fluid level 64 is critically low or empty.

Note that in FIGS. 9 and 10A, the IR transmitter-receiver pairs 90, 96 are positioned such that they would be on the right side of the IR sensor device 50 when in use. In FIG. 10B, the IR transmitter-receiver pairs 90, 96 are positioned on the circuit board 84 on the left side of the IR sensor device 50 when in use. In this manner, IR sensor devices 50 can be made with the IR transmitter-receiver pairs 90, 96 on either the right side of the device 50, or the left side of the device 50. This provides flexibility for the end-user, where the end-user can select which IR sensor device 50 to use based on physical characteristics of the battery 52 to which an IR sensor device 50 will be attached.

In FIGS. 9 and 10A-B, in one example, the Minimum Level IR transmitter-receiver pair 90 include an infrared (IR) light transmitter 92 (i.e., an IR light emitting diode) positioned within the housing 54 to transmit IR light into the fluid 66 of the battery 52, and an IR light receiver 94 (i.e., a photo transistor) positioned within the housing 54 to receive IR light from the IR light transmitter that is reflected by the fluid 66 of the battery 52. This upper IR light transmitter 92 and upper IR light receiver 94 are positioned above the alignment notch 60 of the housing 54.

In one example, the upper/top/first IR light transmitter 92 and upper/top/first IR light receiver 94 are horizontally aligned with one another in parallel, and positioned within the device 50 above the alignment notches/indicator 60 on the housing 54. With this positioning of this upper set/top pair 90 of IR transmitter 92 and IR receiver 94 positioned above the alignment notches/indicator 60 on the housing 54, and when the device 50 is in use and attached to a battery cell 52, this positioning provides for IR light to travel from the upper IR transmitter 92 into the battery cell 52 and reflected back to the upper IR receiver 94 without being optically obstructed or interfered with by the Low-Level fluid line 53 that is printed on or present on the battery cell 52. In one example, the upper/top/first IR light transmitter 92 and upper/top/first IR light receiver 94 are positioned approximately 0.1025 inches above the upper edge of the alignment notches/indicator 60 of the housing 54.

In FIGS. 9, 10A-B, in one example, the Below-Level IR transmitter-receiver pair 96 includes an infrared (IR) light transmitter 98 (i.e., an IR light emitting diode) positioned within the housing 54 to transmit IR light into the fluid 66 of the battery 52, and an IR light receiver 100 (i.e., a photo transistor) positioned within the housing 54 to receive IR light from the IR light transmitter 98 that is reflected by the fluid 66 of the battery 52. This lower IR light transmitter 98 and lower IR light receiver 100 are positioned below the alignment notch 60 of the housing 54.

In one example, the lower/second IR light transmitter 98 and lower/second IR light receiver 100 are horizontally aligned with one another in parallel, and positioned within the device 50 below the alignment notches/indicator 60 on the housing 54. With this positioning of this lower set/pair 96 of IR transmitter 98 and IR receiver 100 positioned below the notches/indicator 60 on the housing 54, and when the device 50 is in use and attached to a battery cell 52, this positioning provides for IR light to travel from the lower IR transmitter 98 into the battery cell 52 and reflected back to the lower IR receiver 100 without being optically obstructed or interfered with by the Low-Level fluid line 53 that is printed on or present on the battery cell 52. In one example, the lower/second IR light transmitter 98 and lower/second IR light receiver 100 are positioned approximately 0.219 inches below the lower edge of the alignment notches/indicator 68 of the housing 54.

As shown in FIG. 3, in one example, the IR sensor device 50 is positioned on a battery cell 52 so that the alignment notches 60 are aligned with the Low-Level line 53 of the battery cell 52 to which the IR sensor device 50 is attached. In this manner, in one example, the IR sensor device 50 will have the Below Level IR transmitter-receiver pair 96 positioned below the low-level line 53 of the respective battery cell 52, and the Minimum Level IR transmitter-receiver pair 90 will be positioned above the low-level line 53 of the battery cell 52.

Referring to FIG. 4A, the IR sensor device 50 is attached to the battery cell 52 so that the notches 60 are aligned with the low-level fluid line 53 of the battery cell 52. In this example, the battery electrolyte fluid level 64 is shown as at a normal level (where the battery fluid level 64 is above the low-level fluid line 53 of the battery 52). In this example, the electrolyte fluid level 64 within the battery cell 52 is above the position of the Minimum Level IR transmitter-receiver (top) pair 90 of the IR sensor device 50.

Referring to FIG. 4B, in this example, the battery electrolyte fluid level 64 is shown as at a below-normal level (where the battery fluid level 64 is below the low-level fluid line 53 of the battery 52). In this example, the electrolyte fluid level 64 within the battery cell 52 is below the position of the Minimum Level IR transmitter-receiver (top) pair 90 of the IR sensor device 50.

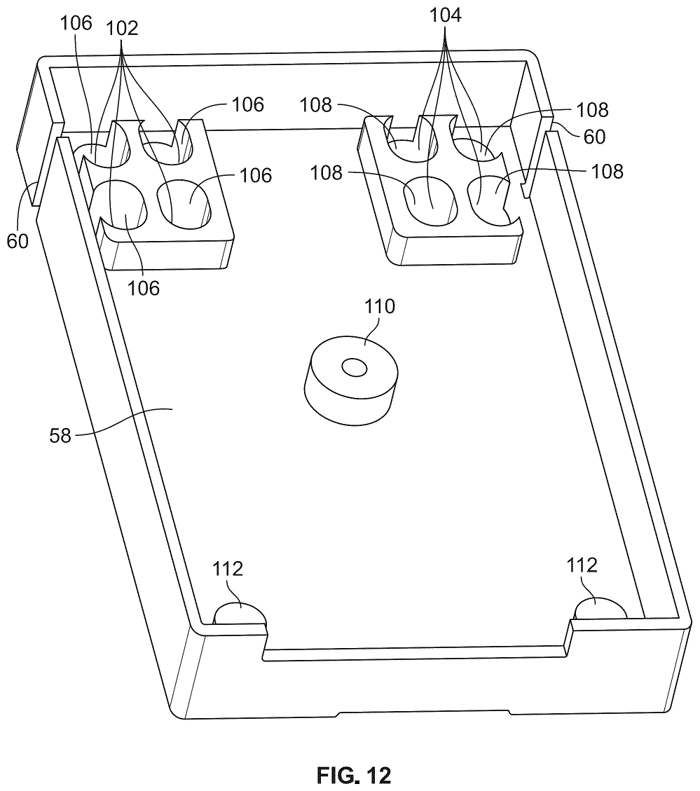

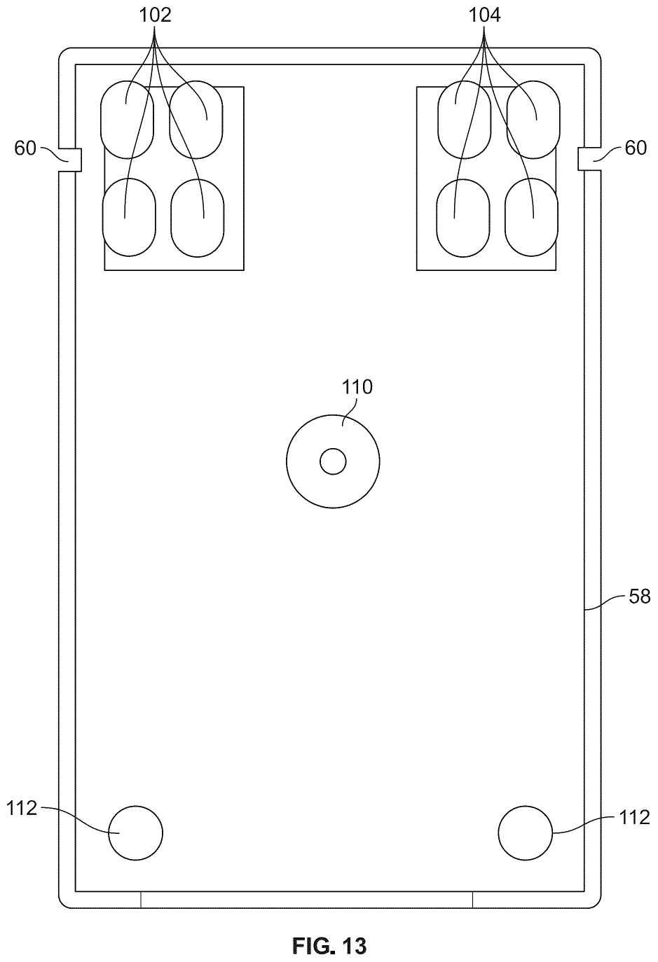

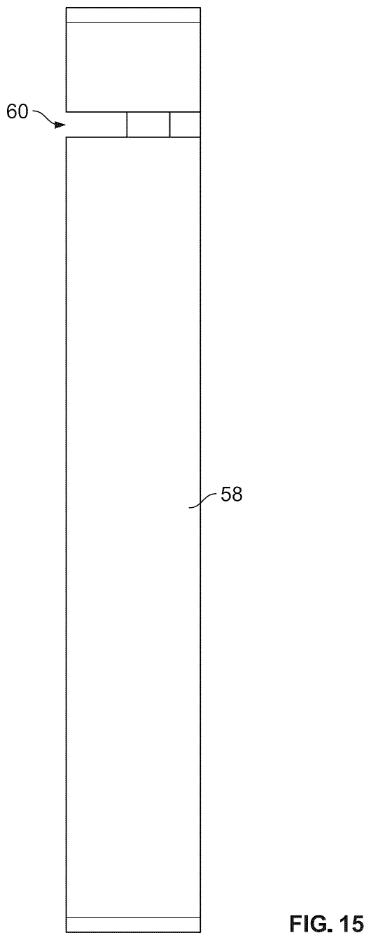

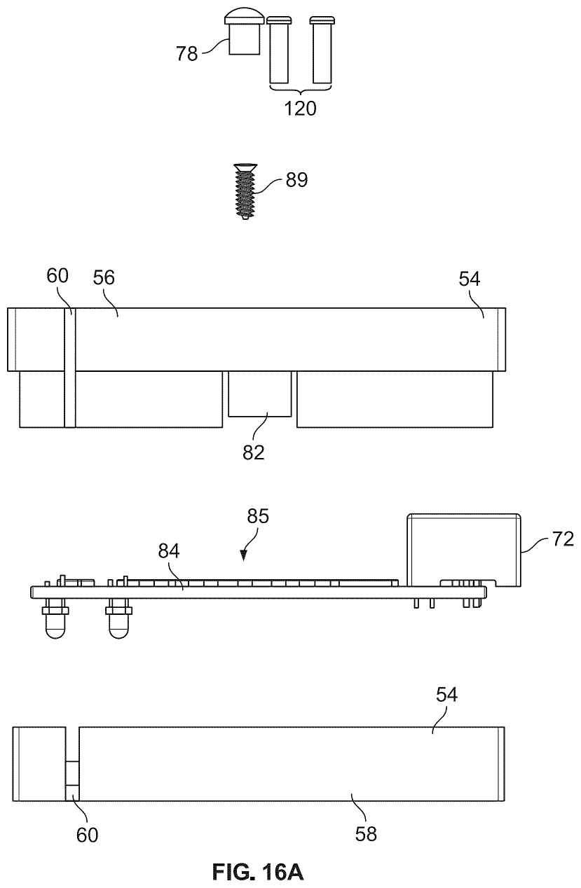

FIGS. 12-15 illustrate the base member 58, in accordance with one embodiment of the present disclosure. Within the interior of the base member 58, two sets of port holes 102, 104 with baffles/support channels 106, 108 are defined as shown in FIGS. 12-13, wherein each port hole 102, 104 is adapted to receive and support an IR transmitter 92, 98 or an IR receiver 94, 100, depending on the Left or Right configuration of device 50 and positioning of IR transmitters and receivers on the circuit board 84.

One or more baffles 106, 108 may be provided in the interior of the base member 58 and positioned around each port hole 102, 104 to provide an enclosure to guide light for transmitters 92, 98 and receivers 94, 100. The baffle 106, 108 around the interior of a port hole for a transmitter 92, 98 helps to guide the light which the device 50 is transmitting from the transmitter 92, 98 into the battery 52, which helps to improve the efficiency and maintain the intensity of the transmitted light into the battery 52. In addition, the baffle 106, 108 around the interior of a port hole 102, 104 for a receiver 94, 100 helps to guide the reflected light from the battery cell 52 to the receiver 94, 100 which the device measures from the battery cell 52, which helps to improve the accuracy of the device's measurement of the reflected light by shielding the receiver 94, 100 from spurious light sources (such as ambient light or other noise); and the baffles 106, 108 around the receiver also help to maintain the intensity of the received reflected light as it is passed to the receiver 94, 100 by reducing losses of the received light, in that the baffle 106, 108 prevents the received reflected light from being distributed outside of the baffle 106, 108 within the housing 54. The depth of each baffle 106, 108 may span on one end from the outer surface of the base member 58, to the circuit board 84 on the other end of the baffle 106, 108.

The base member 58 also includes a receiving post 110 to receive a screw 89 or other element which secures the cover 56, circuit board 84 and base member 58 together. The receiving post 110 of the base member 58 is adapted to receive and securely engage with a self-tapping screw 89. The base member 58 may also include a set of posts 112, along with the receiving post 110 and the interior surfaces of the surrounding support structure of baffles 106, 108; and in combination these elements provide a generally level resting surface that can engage and support the circuit board 84 when the device 50 is fully assembled.

As shown in FIG. 14, the exterior surface 114 of the base member 58 is shown, with the right side port holes 104 and the left side port holes 102. Each of these sets of port holes allows light to pass thru the base member 58 so that the IR transmitters and receivers 92, 98 can detect the fluid level 64 of the adjacent battery cell 52 based on the reflection of the IR light. In one embodiment, a channel 116 is defined in the exterior surface 114 of the base member 58, wherein the channel 116 is adapted to receive a strip of two-sided adhesive tape which can be used to secure the IR sensor device 50 to a battery 52.

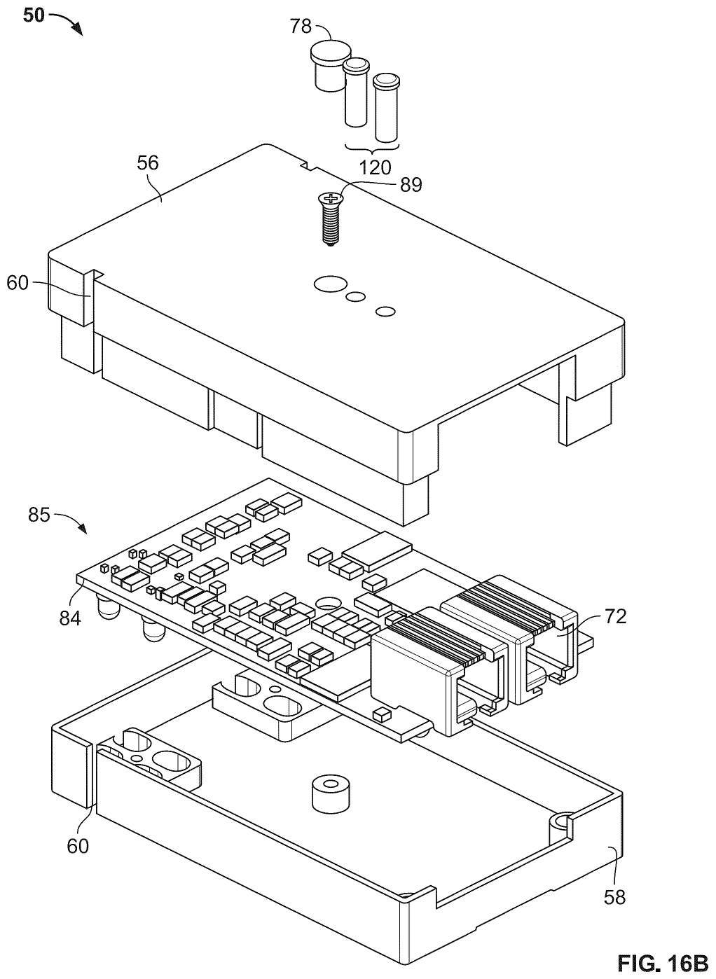

FIGS. 16A-B illustrate an exploded view of an IR sensor device 50 with a cover 56, circuit board 84, and base member 58, in accordance with one embodiment of the present disclosure. The screw 89 is shown that is used to connect the cover 56 with the circuit board 84 and the base member 58. A screw cap 78 to cover screw 89 is also shown which can be attached to the cover 56 to conceal the screw 89, if desired. Light pipe covers 120 can also be used to cover and protect status indicator lights 70.

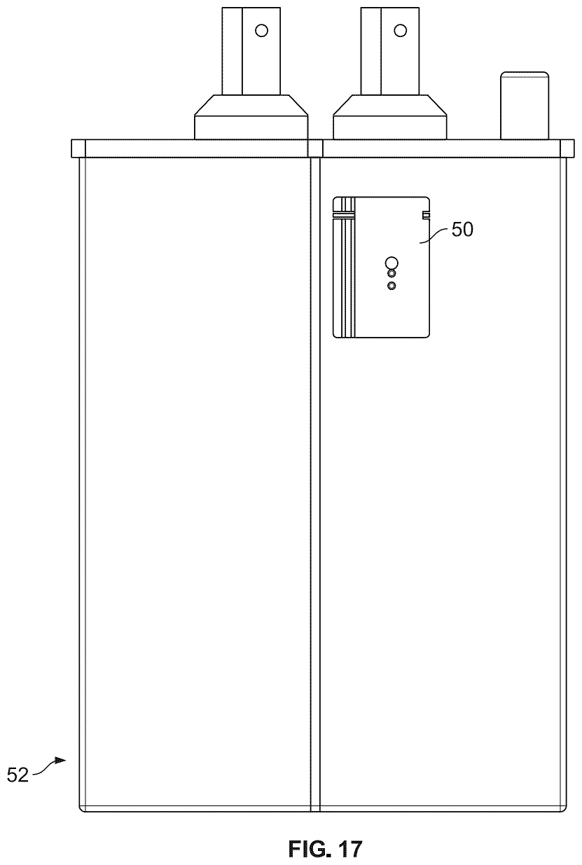

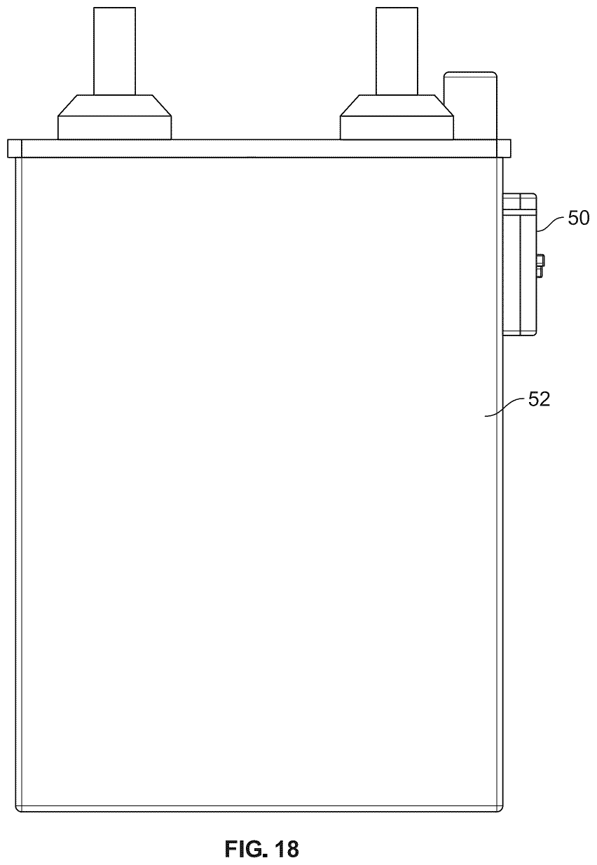

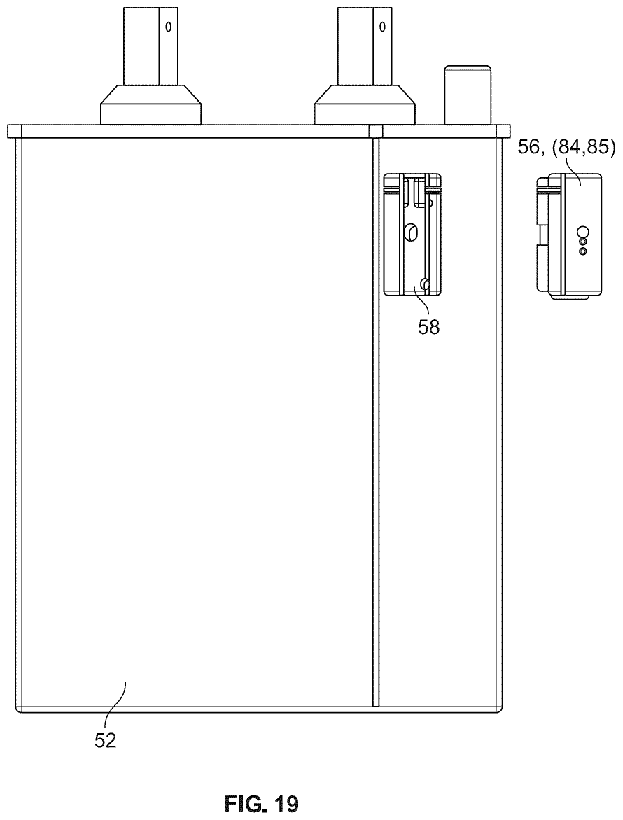

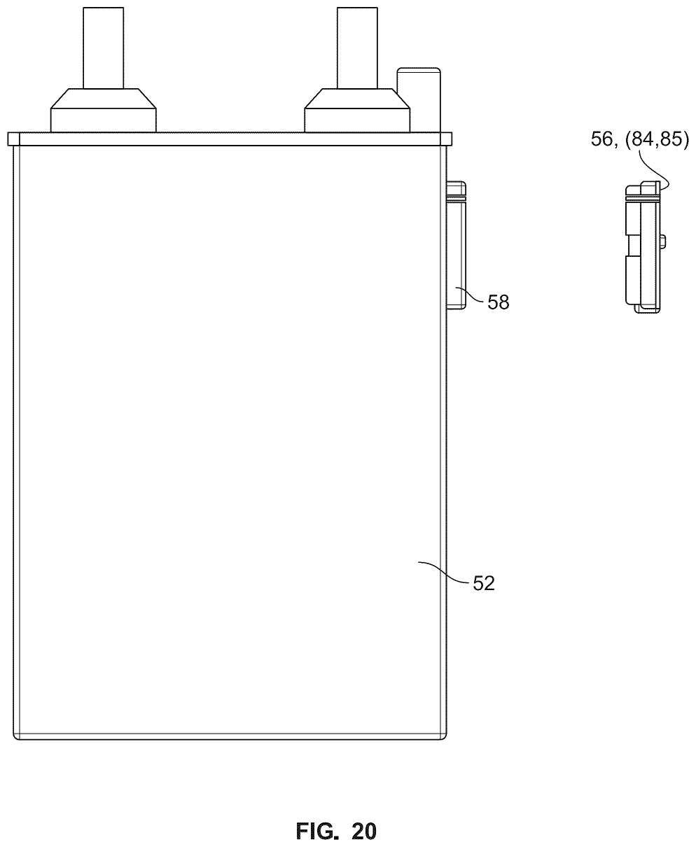

FIGS. 17-18 illustrate an example of an IR sensor device 50 mounted to an exterior surface of a battery cell 52 to detect electrolyte fluid levels 64 in the battery cell 52, in accordance with one embodiment of the present disclosure. In FIGS. 19-20 the cover 56 and circuit board 84 are detached from the base member 58, so that they can be re-used to be connected with other battery cells to monitor their fluid levels.

The IR sensor device 50 can be formed with a compact structure. In one example, the IR sensor device 50 can be approximately 3 inches long, 2 inches wide, and ⅞ inches thick/depth. It is understood that embodiments of the present disclosure can be formed using other dimensions.

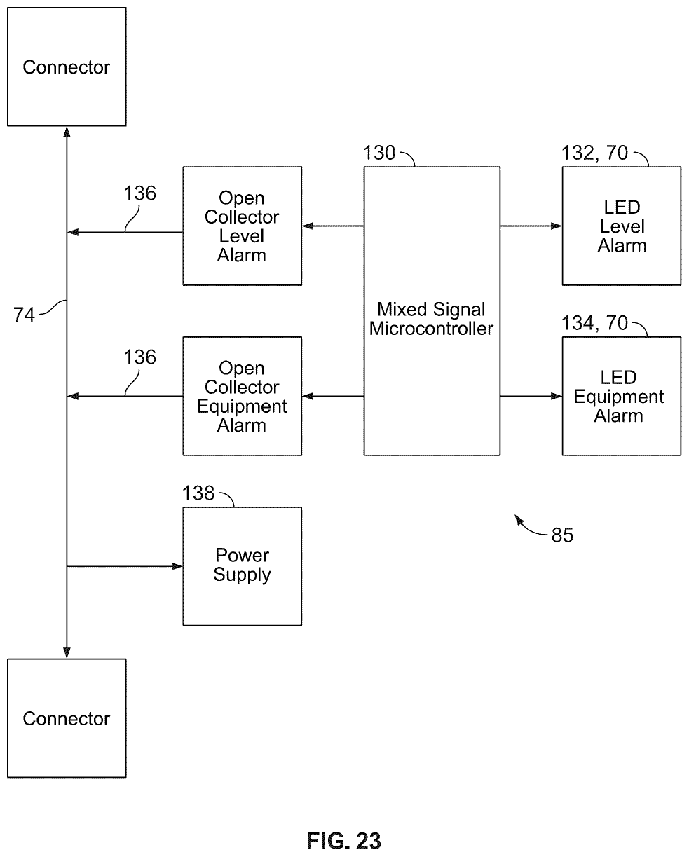

FIG. 23 illustrates a block diagram of an example of an IR sensor device 50 to detect electrolyte fluid levels 64 in a battery cell 52, in accordance with an embodiment of the present disclosure.

As shown in the example of FIGS. 23-24, an IR sensor device 50 includes microcontroller 130 with onboard RAM and ROM memory and analog and digital inputs, as well as analog-to-digital converters and multiplexers/switches. The microcontroller 130 can implement one or more of the processes, operations, steps, functions described herein. The microcontroller 130 can enable/disable the LED status indicators 70, such as a fluid level status/alarm indicator 132, or an equipment alarm 134 indicator. The microcontroller 130 can also control the state of output signals 136 that may be coupled in a Wired-OR configuration using open collector outputs on the signal bus 74.

The IR sensor device 50 may also include a power supply/voltage regulator 138, which regulates and converts 24 VDC down to 3.3 VDC for use by the electronics 85 within the circuit board 84.

As shown in FIG. 24, to drive the Below Level IR transmitter-receiver pair 96 (98, 100), the microcontroller 130 can generate 80 Hz pulse/square wave signals 139 thru a driver 140 to the IR emitting diode 98 which transmits the 80 Hz pulse signal 139 in the form of IR light 141 at 940 nm. The phototransistor (receiver) 100 receives the amount of IR light that is reflected from the electrolyte fluid 66, and generates a received signal 142. The amplitude of the received signal 142 is stored and used by the microcontroller 130 to determine a reference value or baseline data value for self-calibration of the IR sensor device 50.

Likewise, to drive the Minimum Level IR transmitter-receiver pair 90 (92, 94), the microcontroller 130 can generate 80 Hz pulse/square wave signals 144 thru the driver 146 to the IR emitting diode 92 which transmits the 80 Hz pulse signal 144 in the form of IR light 148 at 940 nm. The phototransistor (receiver) 94 receives whatever amount of IR light is reflected from the electrolyte fluid 66, and generates a received signal 150. The amplitude of the received signal 150 is used by the microcontroller 130 to determine whether the electrolyte fluid level 64 within the battery cell 52 has dropped below the Minimum Level 53. Specifically, the amount of reflected IR light (received signal 150) will be compared with reference values (for instance, from signal 142) and if the amount/amplitude of received signal 150 is significantly higher, a low-level electrolyte alarm will be set by device 50.

If the measured reflection of IR light from both phototransistors 94, 100 is high which indicates no electrolyte, the equipment alarm will be enabled by device 50. If the measured reflection by both phototransistors 94, 100 is low and the device 50 determines that the difference small, the electrolyte level 64 is above the low limit 53, and the low-level alarm will be cleared by device 50.

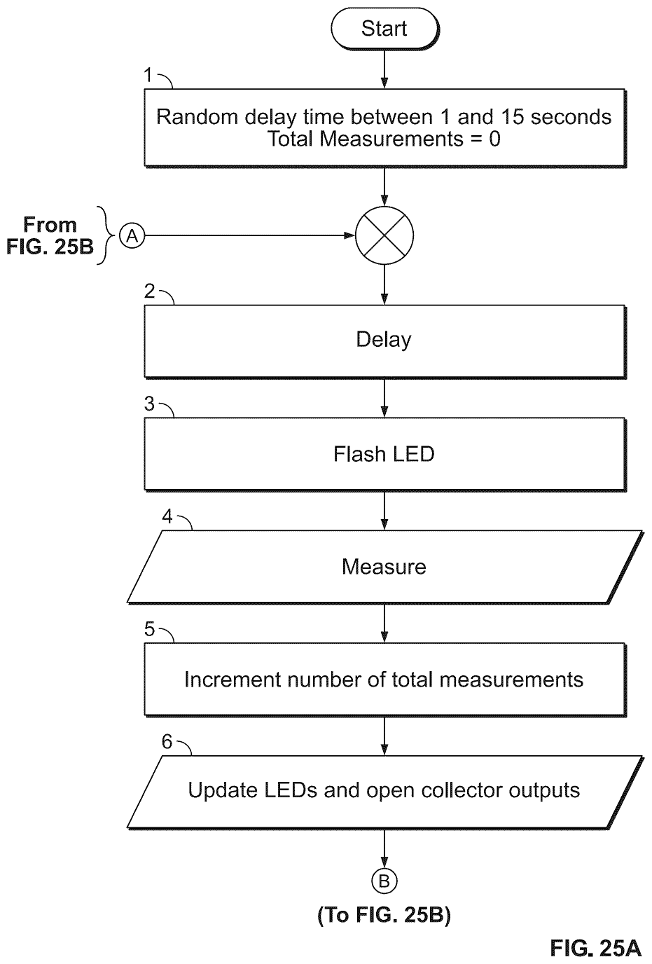

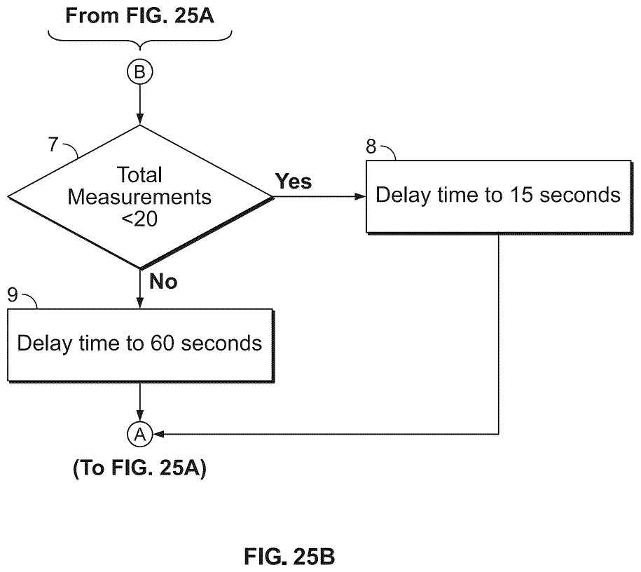

FIGS. 25A-B to 27A-B illustrate examples of processes or operations that device 50 and microcontroller 130 may implement, in accordance with one example of the present disclosure.

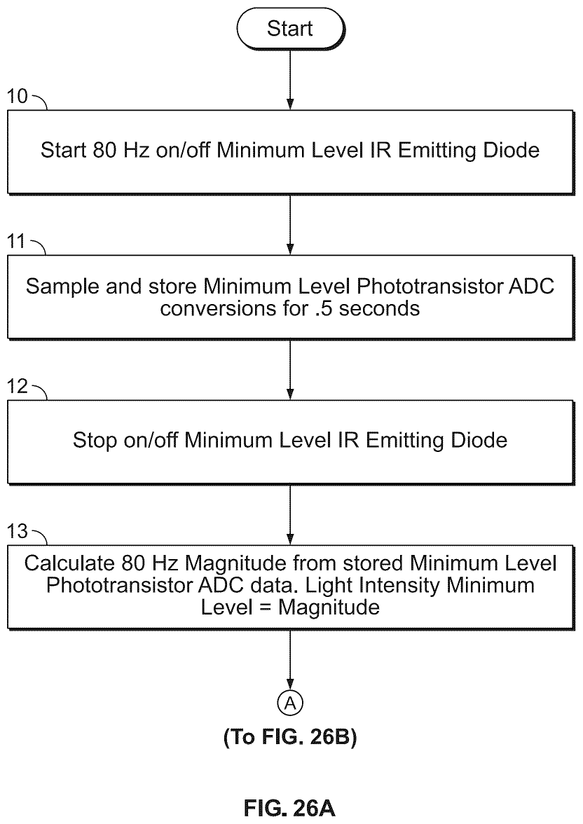

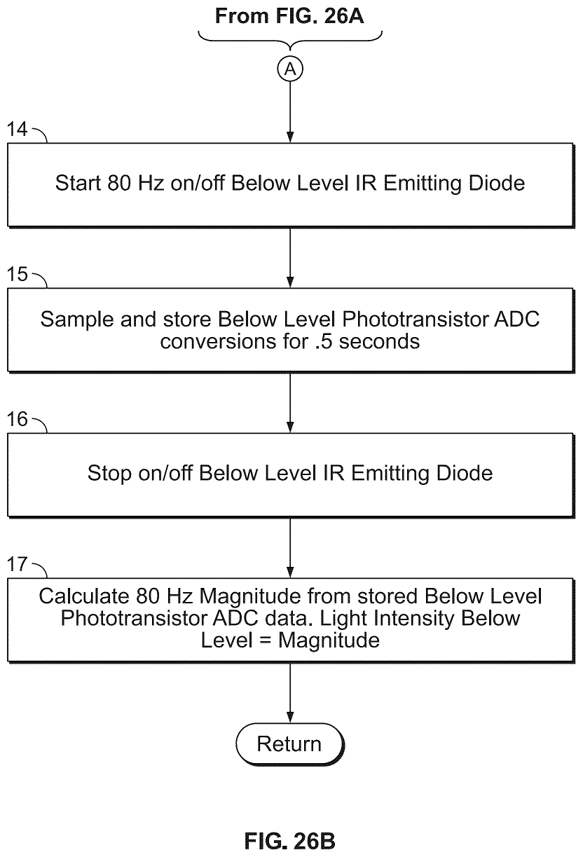

FIGS. 25A-B illustrate an example of a process for an IR sensor device 50 to detect electrolyte fluid levels 64 in a battery cell 52, in accordance with an embodiment of the present disclosure. At operation 1, various initial conditions are established by microcontroller 130, such as a delay time set for 15 seconds, and a counter of Total Measurements is set to zero. At operation 2, the delay is executed based on the current value of the delay time. In FIG. 25A, at operation 3, an LED indicator light can be flashed to indicate that the device is about to take a measurement (such measurement to occur at operation 4). In one example, at operation 3, a green LED indicator is flashed if no alarm was previously present/active prior to taking the next measurement at operation 4. In one example, at operation 3, a red LED indicator is flashed if an alarm was previously present/active prior to taking the next measurement at operation 4. In this manner, operation 3 provides easily understandable visual indicators 70 to a person of the status of the measurements of the device 50. At operation 4, measurement operations are performed by microcontroller 130 according to the processes of FIGS. 26A-B.

At operation 5, the number of total measurements is incremented. At operation 6, the state of the Status LEDs 70 and the state of the Open Collector Output signals are updated, based upon the measurements taken at operation 4. Control is then passed to FIG. 25B, where at operation 7, a determination is made as to whether the total number of measurements is less than a threshold value (i.e., 20 measurements). If so, then at operation 8, the Delay time value is set to 15 seconds and control is returned to operation 2 of FIG. 25A. If operation 7 determines that the total number of measurements is not less than a threshold value (i.e., of 20 measurements), then at operation 9 the Delay time value is set to 60 seconds and control is returned to operation 2 of FIG. 25A. In this manner, by now taking measurements less frequently (i.e., every 60 seconds), the process reduces the amount of energy used by the IR sensor device 50.

FIGS. 26A-B illustrate an example of another process for an IR sensor device 50 to detect electrolyte fluid levels 64 in a battery cell 52, in accordance with an embodiment of the present disclosure. At operation 10, the minimum level IR emitting diode 92 is pulsed at 80 Hz. At operation 11, the minimum level phototransistor/receiver 94 is sampled by microcontroller 130, and the results are stored. In one example, operation 11 samples the received signals for approximately 0.5 seconds. At operation 12, the pulsing of the minimum level IR emitting diode 92 is stopped. At operation 13, the magnitude of the received minimum level signal from receiver 94 is calculated, based upon the intensity of the received infrared light.

Control is then passed to operation 14 of FIG. 26B. At operation 14, the below level infrared emitting diode 98 begins to be pulsed at a rate of 80 Hz. At operation 15, the signal received by the phototransistor 100 is sampled, stored, and converted digitally for approximately 0.5 seconds. At operation 16, the pulsing of the below level IR emitting diode 98 is stopped. At operation 17, the magnitude of the received Below Level signal from receiver 100 is calculated, based upon the intensity of the received infrared light.

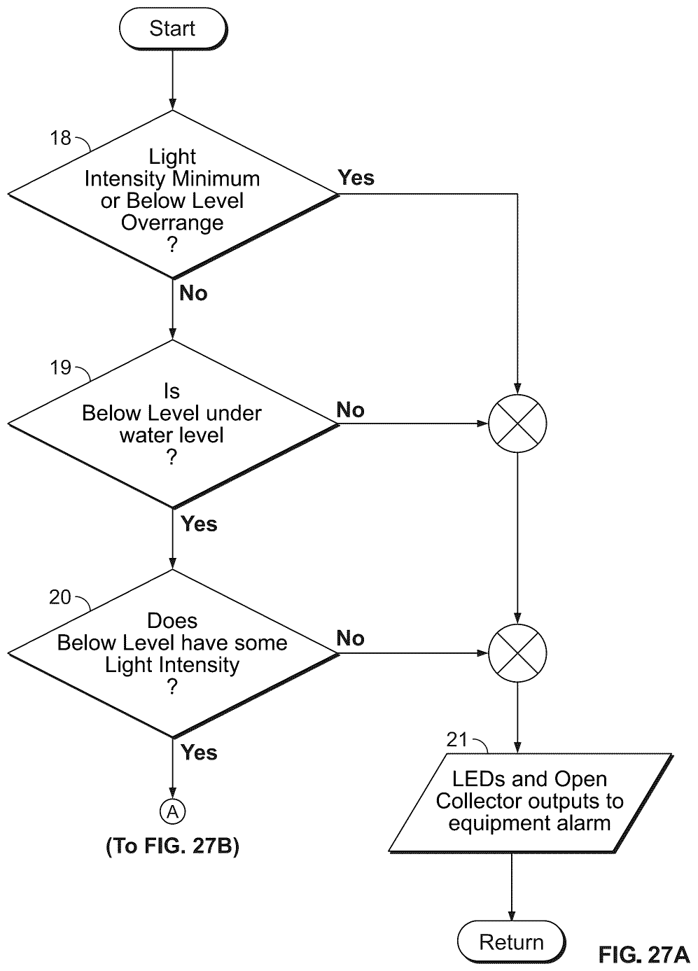

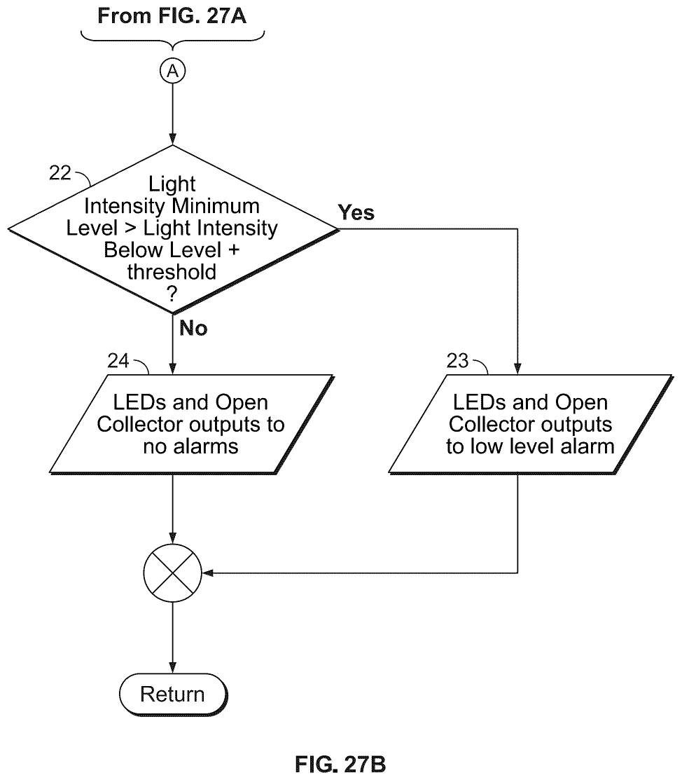

FIGS. 27A-B illustrate an example of another process for an IR sensor device to detect electrolyte fluid levels 64 in a battery cell 52, in accordance with an embodiment of the present disclosure. These figures illustrate the series of detection steps that can be used by microcontroller 130 to detect various conditions. At operation 18, a determination is made as to whether the light intensity Minimum amounts 150 or the light intensity below level amounts 142 are over-ranged. Operation 18 for instance can be used to determine whether the user placed the IR sensor device 50 on the battery cell 52 improperly, for instance next to battery plates which have a very high reflectance, or next to the fill tubes of the battery cell 52, or next to other internal structures of the battery cell 52. If so, then control is passed to operation 21 which activates the LED status indicators 70 and activates the open collector outputs to indicate an equipment alarm.

If not, control is passed to operation 19. Operation 19 determines whether the Below Level IR sensors 100 are under the water level 64 of the battery cell 52. Operation 18 can be utilized by microcontroller 130 to detect whether a set-up error occurred, for instance if the IR sensor device 50 was placed or positioned above the water level 64 of the battery cell 52. If so, then control is passed to operation 21 which activates the LED status indicators 70 and activates the open collector outputs to indicate an equipment alarm.

If not, control is passed to operation 20. Operation 20 determines whether the below level detectors 100 have detected some light intensity. This operation can be used to determine whether the IR sensor module 50 may have fallen off or been dislodged from the battery cell 52. If so, then control is passed to operation 21 which activates the LED status indicators 70 and activates the open collector outputs to indicate an equipment alarm.

If not, control is passed to operation 22 of FIG. 27B. At operation 22, the light intensity measured by the Minimum level detector 94 is compared with the light intensity measured by the Below level detector 100 plus some threshold. If the Minimum level detector 94 detects light intensity that is greater than the Below level detector 100 light intensity plus some threshold, then this condition indicates that there is less electrolyte fluid 66 within the battery cell 52, and therefore control is passed to operation 23 where the LED status indicators 70 and the open collector outputs are activated to generate an alarm indicating a low fluid level within the battery cell 52.

If not, then control is passed to operation 24, where the LED status indicators 70 and the open collector outputs are set to indicate no alarms (or any existing alarms are cleared), and control is returned to operation 18 of FIG. 27A.

The operations of FIGS. 27A-B are continuously repeated to check the fluid levels 64 in the battery cell 52—for instance, every 60 seconds during steady state operations of the IR sensor device 50.

Hence, it can be seen that the various embodiments of the present disclosure provide an IR sensor device 50 and related methods that can detect low levels of electrolyte fluids 66 within an adjacent battery cell 52.

Embodiments of the present disclosure can be used with various types of batteries 52 or battery cells 52, such as but not limited to vented led acid (VLA) batteries, flooded cell batteries, NiCad batteries, or batteries that have a clear or translucent outer case. Embodiments of the present disclosure can be used in various applications where batteries 52, banks of batteries 52, or battery backup systems are used—such as but not limited to battery backup systems for data centers, electrical power systems including substations, computing systems, telephony systems, cell phone towers, or other systems that use electrical power.

In this description, references to “one embodiment” or “an embodiment,” or to “one example” or “an example” mean that the feature being referred to is, or may be, included in at least one embodiment or example of the disclosure. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations is not a limitation of the present disclosure.

It should be appreciated that in the foregoing description of exemplary embodiments of the disclosure, various features of the disclosure are sometimes grouped together in a single embodiment, figure, or description thereof for the purpose of streamlining the disclosure and aiding in the understanding of one or more of the various aspects. This method of disclosure, however, is not to be interpreted as reflecting an intention that an embodiment requires more features than are expressly recited in each claim. Rather, inventive aspects lie in less than all features of a single foregoing disclosed embodiment, and each embodiment described herein may contain more than one inventive feature.

It will be understood by those skilled in the art that various changes in the form and details may be made from the embodiments shown and described without departing from the spirit and scope of the disclosure.

1. A device to detect the level of fluid within a battery, the battery having a low-level fluid line, comprising:
a housing having an indicator on the housing adapted to be aligned with the low-level fluid line of the battery, the housing adapted to be attached to an outside surface of the battery;
a first infrared (IR) light transmitter positioned within the housing, the first transmitter transmitting IR light into the fluid of the battery;
a first IR light receiver positioned within the housing, the first IR light receiver receiving IR light from the first IR light transmitter that is reflected by the fluid of the battery;
wherein the first IR light transmitter and first IR light receiver are positioned above the indicator;
a second IR light transmitter positioned within the housing, the second transmitter transmitting IR light into the fluid of the battery; and
a second IR light receiver positioned within the housing, the second IR light receiver receiving IR light from the second IR light transmitter that is reflected from the fluid of the battery;
wherein the second IR light transmitter and second IR light receiver are positioned below the indicator.

2. The device of claim 1, wherein the first IR light transmitter is a light emitting diode (LED) generating IR light at a wavelength of 940 nano meters.

3. The device of claim 1, wherein the first IR light receiver is a photo transistor.

4. The device of claim 1, wherein the IR light from the second IR light transmitter is detected by the second IR light receiver to determine a reference value of reflected IR light through the fluid.

5. The device of claim 1, wherein the IR light from the first IR light transmitter is detected by the first IR light receiver to determine the level of the fluid relative to the low-level fluid line in order for the device to generate an initial warning if the level of the fluid falls below the low-level fluid line.

6. The device of claim 1, wherein the IR light from the second IR light transmitter is detected by the second IR light receiver to determine the level of the fluid relative to the low-level fluid line in order for the device to generate an urgent critical warning if the level of the fluid falls substantially below the low-level fluid line.

7. The device of claim 1, wherein the indicator is a pair of lateral alignment notches defined in the housing.

8. The device of claim 1, further comprising a circuit board having control electronics and the circuit board including the first IR light transmitter, the first IR light receiver, the second IR light transmitter and the second IR light receiver; and wherein the housing includes a base member and a removable cover, the cover connected with the base member; wherein the circuit board is attached to the cover.

9. The device of claim 8, wherein when the housing is attached to the battery cell, the cover and circuit board are detachable from the base member and the battery cell.

10. The device of claim 1, wherein the first IR light transmitter and the first IR light receiver are vertically aligned with the second IR light transmitter and the second IR light receiver.

11. The device of claim 1, wherein the first IR light transmitter pulses the IR light at a frequency of 80 Hz.

12. The device of claim 11, wherein the first IR light receiver receives the IR light from the first IR light transmitter at the pulsed 80 Hz frequency and in phase with the 80 Hz IR light.

13. The device of claim 1, wherein the second IR light transmitter pulses the IR light at a frequency of 80 Hz.

14. The device of claim 13, wherein the second IR light receiver receives the IR light from the second IR light transmitter at the pulsed 80 Hz frequency and in phase with the 80 Hz IR light.

15. A device to detect the level of fluid within a battery, the battery having a low-level fluid line, comprising:
a housing having at least a pair of alignment notches defined in the housing, the notches adapted to be aligned with the low-level fluid line of the battery, the housing adapted to be attached to an outside surface of the battery;
a first infrared (IR) light transmitter positioned within the housing, the first transmitter transmitting IR light into the fluid of the battery;
a first IR light receiver positioned within the housing, the first IR light receiver receiving IR light from the first IR light transmitter that is reflected by the fluid of the battery;
wherein the first IR light transmitter and first IR light receiver are positioned above the notches;
a second IR light transmitter positioned within the housing, the second transmitter transmitting IR light into the fluid of the battery; and
a second IR light receiver positioned within the housing, the second IR light receiver receiving IR light from the second IR light transmitter that is reflected from the fluid of the battery;
wherein the second IR light transmitter and second IR light receiver are positioned below the notches.

16. The device of claim 15, wherein the first IR light transmitter is a light emitting diode (LED) generating IR light pulsed at a frequency of 80 Hz, the IR light having a wavelength of 940 nano meters.

17. The device of claim 15, wherein the IR light from the second IR light transmitter is detected by the second IR light receiver to determine a reference value of reflected IR light through the fluid.

18. The device of claim 15, wherein the IR light from the second IR light transmitter is detected by the second IR light receiver to determine the level of the fluid relative to the low-level fluid line in order for the device to generate an urgent critical warning if the level of the fluid falls substantially below the low-level fluid line.

19. The device of claim 15, further comprising a circuit board having control electronics and the circuit board including the first IR light transmitter, the first IR light receiver, the second IR light transmitter and the second IR light receiver; and wherein the housing includes a base member and a removable cover, the cover connected with the base member; wherein the circuit board is attached to the cover; and wherein when the housing is attached to the battery cell, the cover with the circuit board are detachable from the base member and the battery cell.

20. The device of claim 19, wherein the base member defines a first baffle positioned around a portion of the first IR light receiver; and wherein the base member defines a second baffle positioned around a portion of the second IR light receiver.
